(19) United States
(12) Patent Application Publication
(10) Pub. No.: US 2015/0212730 A1
(43) Pub. Date: Jul. 30, 2015

(54) TOUCH EVENT ISOLATION METHOD AND RELATED DEVICE AND COMPUTER READABLE MEDIUM

(71) Applicant: MediaTek Singapore Pte. Ltd., Singapore (SG)

(72) Inventors: Qinglei Liu, Chengdou City (CN); Kai-Wen Liu, Taipei City (TW); Cunliang Zou, Chengdou City (CN)

(21) Appl. No.: 14/606,021

(22) Filed: Jan. 27, 2015

(30) Foreign Application Priority Data
Jan. 28, 2014 (CN) 201410042309.7

(51) Int. Cl. G06F 3/0488; G06F 3/041; G06F 3/0481

(52) U.S. Cl. CPC G06F 3/04886; G06F 3/0481; G06F 3/04883; G06F 3/0418

(57) ABSTRACT

A touch event isolation method and related apparatus. The touch event isolation method includes: determining an isolation area in a user interface displayed by a touch device; and blocking a touch event occurring on the isolation area. The touch event isolation method and apparatus of present invention can avoid touch events from mistakenly occurring on the user interface displayed by the touch device.

### BACKGROUND

The present invention relates generally to touch controlled device, and more particularly, to a touch event isolation method, a touch event isolation device and related computer readable medium used in a touch controlled device for processing touch events.

With progress and development of touch control and display technologies, touch controlled devices are getting more and more popular. The intuitive control of the touch controlled device provides higher convenience to the user and improves the efficiency of user's manipulations. However, modern touch controlled devices are mostly medium-sized and small-sized electronic devices. Hence, their limited-sized displays may lead to occurrence of unintentional touches and further cause current manipulations to be interrupted.

Too many objects existing in a user interface may cause unintentional touches. When these objects are close to an object that the user intends to control, it becomes difficult for the user to precisely and exactly touch on the intended object. Unintentional touches may cause user's current manipulations to be interrupted. The user has to perform extra procedures and wastes extra time to return previous manipulations. The following reasons may lead to the unintentional touches.

First type of the unintentional touches occurs on advertising areas. When some applications are executed, specific areas in the user interface will display advertisement contents of sponsors. This usually could be seen in free software programs. When the user unintentionally touches the advertising areas or sliding finger onto the advertising areas while executing such applications, execution of the applications could be interrupted or paused. If this happens in game applications, this is unacceptable because the user may lose the progress of the game or leads to unwanted game controls. FIG. 1 illustrates a user interface simultaneously displays game contents and advertisement contents while a game application are being executed. As shown by FIG. 1, the area displaying the advertisement contents is close to gaming area. Hence, it easily leads to the unintentional touches.

Second type of the unintentional touches is related to the operating system (OS). Generally, the OS of the touch controlled device provides a navigation bar as a part of the user interface. FIG. 2 illustrates a navigation bar of the user interface while the user executes a gaming application. As shown by FIG. 2, the navigation bar at the bottom of the user interface usually provides: “back”, “home” and “task” function options. When a specific application is executed by the user, all applications are running in the background can be presented if the user selects “task” option. “Back” option allows the user to return back to the previous user interface or exit current operations. Further, “home” option allows the user to exit the currently-running application and return back to the desktop or returning to the topmost layer of all operating contents. When some applications are running, such navigation bar will not be hidden and still exists at the bottom of the user interface. If the user unintentionally touches the options of the navigation bar, user's current manipulations will be interrupted.

Third type of the unintentional touches occurs when the touch controlled device performs multimedia playback. FIG. 3 illustrates unintentional touches occurs when the user uses the touch controlled device for multimedia playback. Usually, when the multimedia player plays the multimedia, the content of multimedia will be fitted to the full screen, making the user can comfortably view the content of the multimedia. However, if the user unintentionally touches some area of the touchscreen, the playback will be suspended or stopped. If the multimedia is streaming, all the buffered data could be cleared. The user has to wait the multimedia player to buffer the streaming multimedia again such that the progress of the playback can be recovered.

In view of above, some disadvantages of the touch controlled device need to be overcome.

### SUMMARY

According to a first aspect of the present invention, a touch event isolation method for processing a touch event of a touch controlled device comprising: determining an isolation area of a user interface displayed by the touch controlled device; and blocking the touch event occurring on the isolation area.

According to a second aspect of the present invention, a touch event isolation device for processing a touch event in a touch controlled device comprising: a determination module and a block module. The determination module is employed for determining an isolation area of a user interface displayed by the touch controlled device. The blocking module is employed for blocking the touch event occurring on the isolation area.

According to a third aspect of the present invention, a computer readable medium containing a set of computer readable instructions that when loaded into a computer configure that computer to: determining an isolation area of a user interface displayed by the touch controlled device; and blocking the touch event occurring on the isolation area.

The touch event isolation method and the touch event isolation can avoid undesirable effects of the unintentional touches on the user interface of the touch controlled device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-3 illustrate how unintentional touches occur.

FIG. 4 illustrates a flow chart of a touch event isolation method according to one embodiment of the present invention.

FIG. 5 illustrates a touch controlled device executing a touch event isolation method according to one embodiment of the present invention.

FIG. 6 illustrates a flow chart regarding activation of isolation mechanism according to one embodiment of the present invention.

FIG. 7 illustrates a flowchart of generating a notice message for inquiring whether to de-activate the isolation mechanism according to one embodiment of the present invention.

FIG. 8 illustrates a lock icon generated according to one embodiment of the present invention.

FIG. 9 illustrates a schematic diagram of a touch controlled device 200 according to one embodiment of the present invention.

FIG. 10 illustrates a time sequence of a flow of adding an isolation window according to one embodiment of the present invention.

FIG. 11 illustrates a time sequence of a flow of adding an isolation window according to one embodiment of the present invention.

FIG. 12 illustrates a time sequence of a flow of activating the isolation mechanism according to one embodiment of the present invention.

FIG. 13 illustrates a time sequence of a flow of generating a fake window according to one embodiment of the present invention.

FIG. 14 illustrates a flow chart regarding activation of isolation mechanism according to one embodiment of the present invention.

FIG. 15 illustrates how the touch event isolation method is implemented based on software architecture according to one embodiment of the present invention.

FIG. 16 illustrates a diagram of a touch event isolation device according to one embodiment of the present invention.

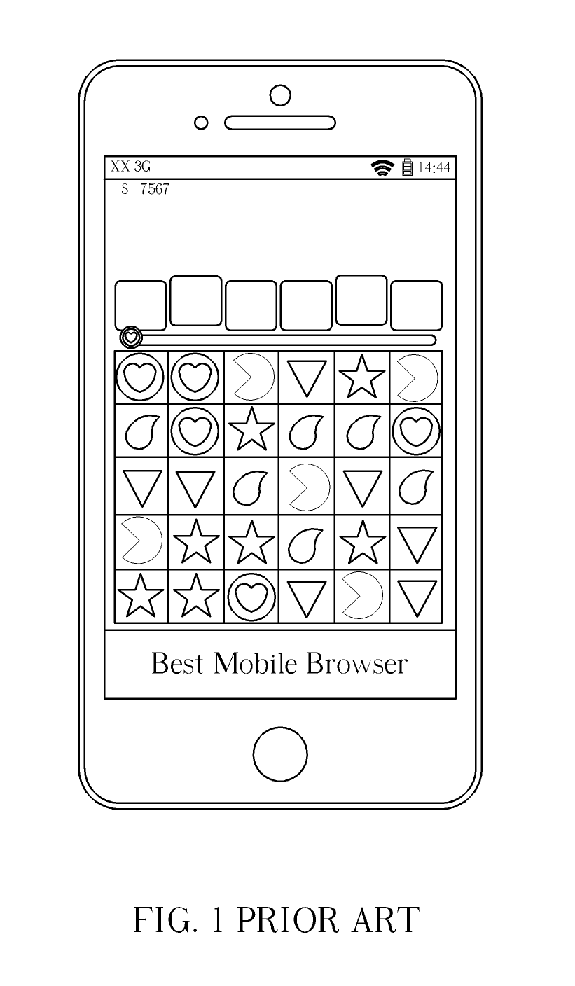

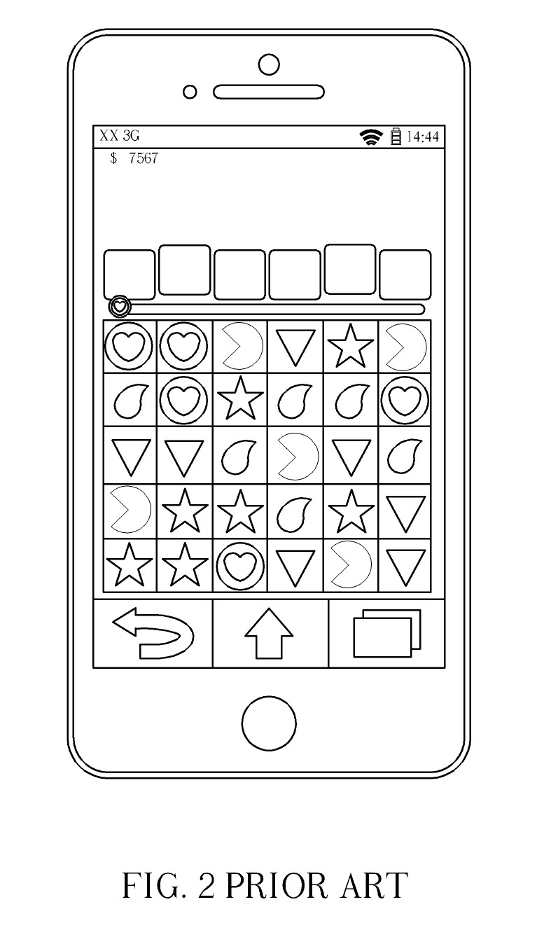

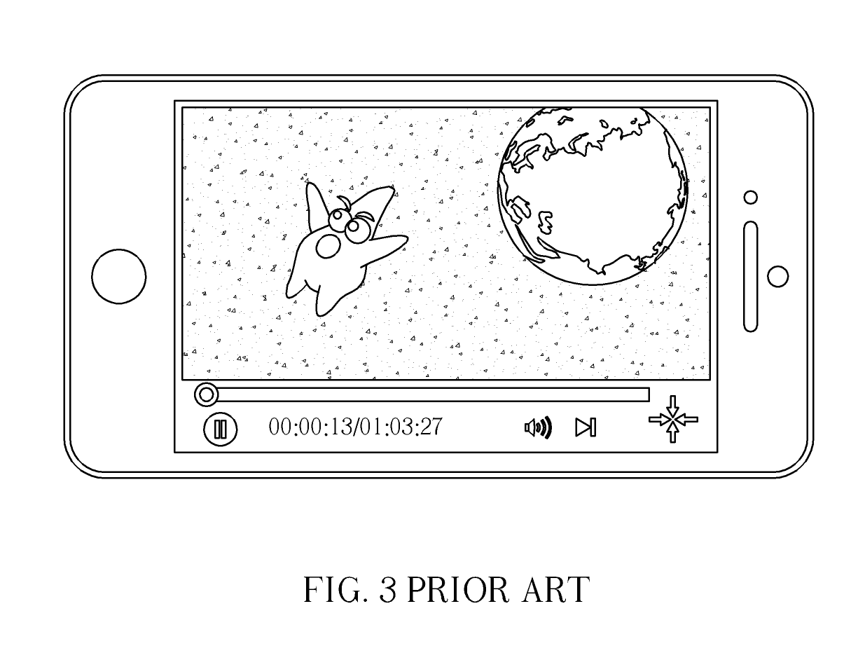

### DETAILED DESCRIPTION

The present invention provides an isolation mechanism to prevent unintentional touches from affecting user's manipulation. The isolation mechanism determines specific areas of the user interface to be isolated, and blocking all touch events regarding the isolated areas. Even though the user unintentionally touches the isolated areas, user's manipulation will not be interrupted because the isolation mechanism blocks the touch events. According to various embodiments, several ways of determining the isolation area are provided. Some embodiments having high flexibility allow the users to configure the isolation area on their own. In some embodiments, the isolation area is automatically determined, in which the isolation mechanism detects the advertising area or the navigation bar of the OS, and isolates these areas. In some embodiments, the isolation mechanism monitors executions of specific applications and automatically generates isolation windows. The user could configure the isolation windows to set up the isolation area. The present invention provides different implementations to address the unintentional touch issue, thereby improving the convenience of touch control. Further details of the isolation mechanism are presented as below.

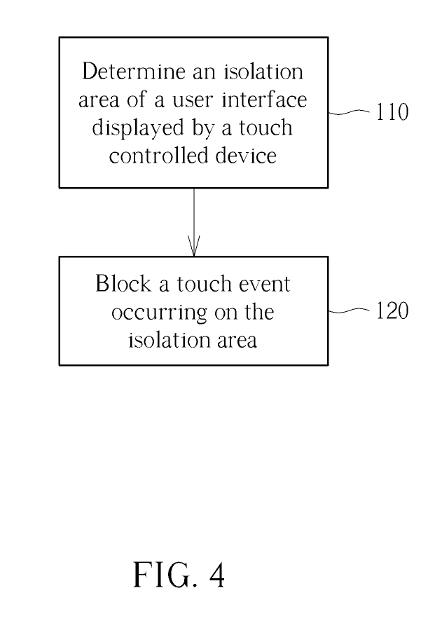

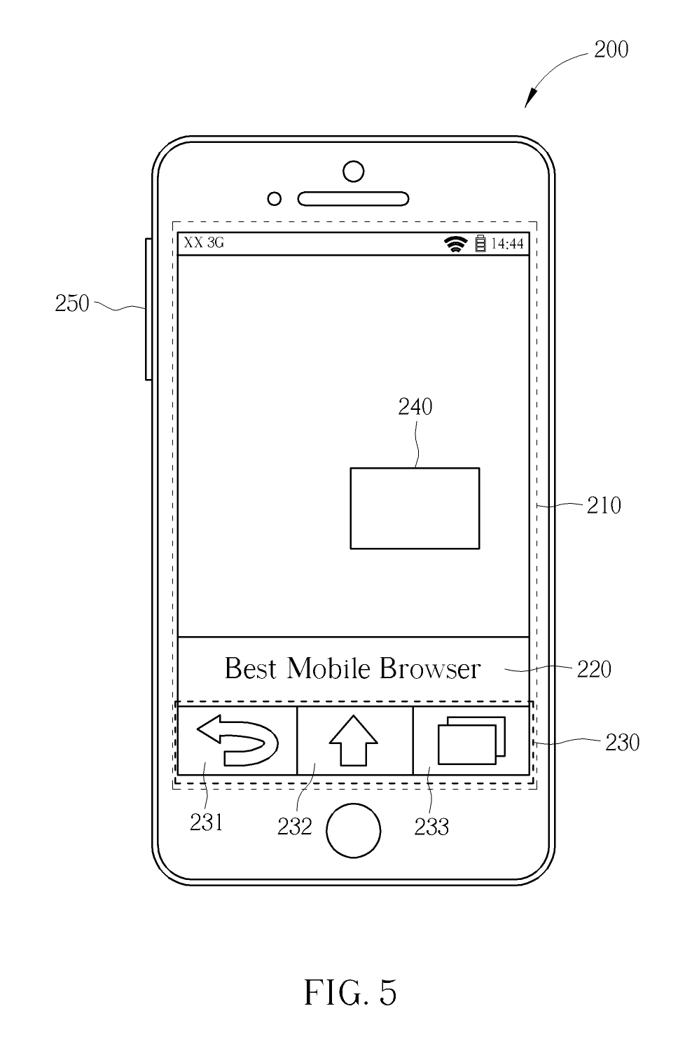

FIG. 4 illustrates a flow chart regarding how a touch event isolation method processes a touch event of a touch controlled device according to one embodiment of the present invention. Please refer to FIG. 4 in conjunction with FIG. 5 illustrating a touch controlled device 200 according to one embodiment of the present invention. The touch controlled device 200 could be a smartphone, a tablet, or any electronic device with touch sensing functionality.

In step 110, determining an isolation area of a user interface 210 of the touch controlled device 200. For example, determining the advertising area 220 as the isolation area could address the issue of the unintentional touches on the advertising area 220; determining the navigation bar 230 as the isolation area could address the issue of the unintentional touches on the navigation bar 230. In this step, depending on different requirements, multiple areas could be determined as the isolation area. In step 120, the touch event occurring on the determined isolation area is blocked. Hence, all the unintentional touches on the isolation area will not affect the user interface 210, or interrupt/pause user's current manipulation. According to various embodiments of the present invention, step 110 and step 120 could have different implementations as illustrated below.

### First Embodiment

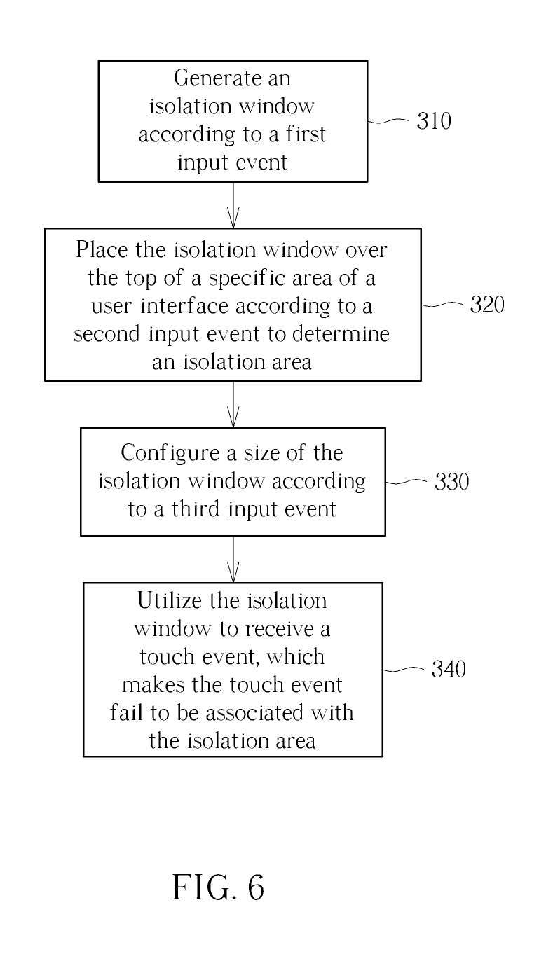

In the first embodiment of the present invention, the isolation mechanism could be activated by user's specific manipulation. Please refer to FIG. 6 illustrating a flow chart of activating the isolation mechanism according to one embodiment of the present invention. In step 310, an isolation window is generated according to a first input event, where the first input event is generated by the user performing specific operations. For example, the user could press and hold on any one of function options (e.g. back option 231, home option 232 or task option 233) of the navigation bar 230 of the touch controlled device 200, or simultaneously press several ones of function options (e.g. back option 231, home option 232 and task option 233) to generate the first input event. Please note that this is not intended to be a limitation of the present invention. Any user's operations, such as, touch input or non-touch input (via physical buttons), could generate the first input event.

When user's operation has been done to accordingly generate the first input event, generates an isolation window 240 above the user interface 210, which is superimposed onto the user interface 210 and could be transparent or translucent. Therefore, the isolation window 240 does not affect visualization of the user interface 210. Then, in step 320, place the isolation window 240 over the top of a specific area of the user interface 210 according to a second input event. Because the user could be prevent the unintentional touches from affecting different areas, the isolation window 240 will be placed and superimposed onto different areas, such as advertising area 220 or the navigation bar 230. Also, because the user would prevent the unintentional touches from affecting different areas simultaneously, more than one isolation window 240 could be generated in step 310 and cover multiple areas of the user interface (in step 320). In step 320, the position of the isolation window 240 could be adjusted according to the second input event generated by the user. The user could use his/her finger to drag the isolation window 240 via the touchscreen of the touch controlled device 200. When the isolation window 240 is dragged onto the top of the advertising area 220, the advertising area 220 is isolated and becomes the isolation area. When the isolation window 240 is dragged onto the top of the navigation bar 230, the navigation bar 230 is isolated and becomes the isolation area. Furthermore, if multimedia playback is being performed, the whole user interface could be determined as the isolation area to avoid the suspending of playback.

In one embodiment, an extra step 330 could be added to this flow. Step 330 determines a size of the isolation window 240 according to a third input event. For example, the user may pinch his/her double fingers on the touchscreen of the touch controlled device 200 to scale the size of the isolation window 240 or drag a corner of isolation window 240 to scale the size of the isolation window 240. By doing so, the size of the isolation window 240 could be adjusted to fit the size of the desired isolation area. For example, the isolation window 240 could precisely cover the advertising area 220 or the navigation bar 230 of the user interface 210. As a result, the isolation window 240 will not affect user's manipulation on others area of the user interface 210. Please note that steps 320 and 330 may not be necessary. If in step 310, the position and the size of the isolation window 240 are exactly fit and aligned to the advertising area 220, step 320 and step 330 could be omitted. Besides, step 320 and step 330 need not be executed in the exact order shown by figure. In some embodiments, step 330 could be performed prior to step 320. That is, before the position of the isolation window 240 is adjusted in step 320, the step 330 could be performed to determine the size of the isolation window 240. In step 320 or step 330, the second and third input events could be generated by methods other than touch control operations. For example, through physical buttons 250 of the touch controlled device 200, the isolation window 250 could be moved and scaled.

After superimposing the isolation window 240 above the specific area to determine isolation area through the above-mentioned steps, the flow goes to step 340, where the isolation window 240 is utilized to receive user's touch event, which makes the touch event fail to be associated with the isolation area. For example, after the advertising area 220 or the navigation bar 230 is determined as the isolation area, the touch controlled device 200 will recognize the touch event is associated with the isolation window 240 rather than the advertising area 220 or the navigation bar 230 placed underneath if the user unintentionally touches on the isolation area. This is because the isolation window 240 is over the top of the advertising area 220 or the navigation bar 230. As a result, the undesirable effects of the unintentional touches can be avoided, such as jumping from the current user interface 210 to the web page corresponding to advertisement contents or the OS performing the operations corresponding to the function options in the navigation bar.

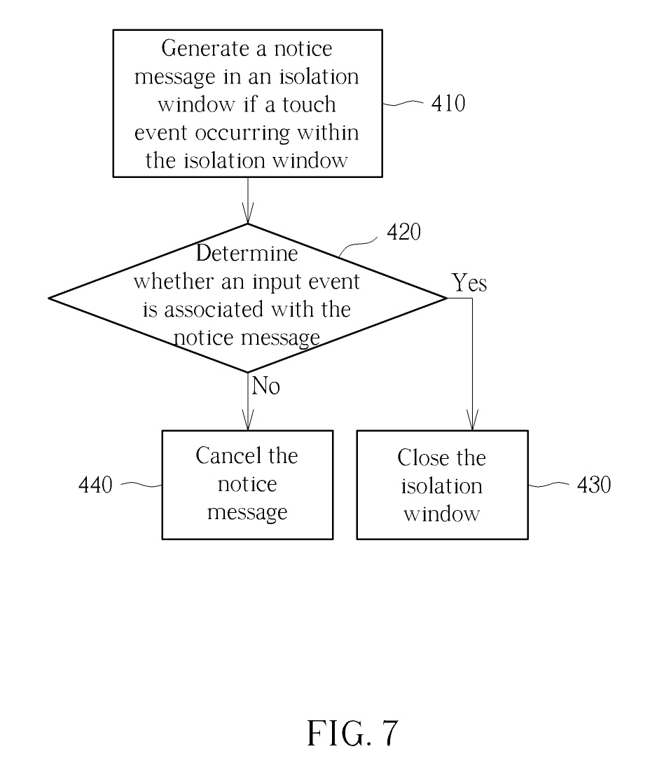

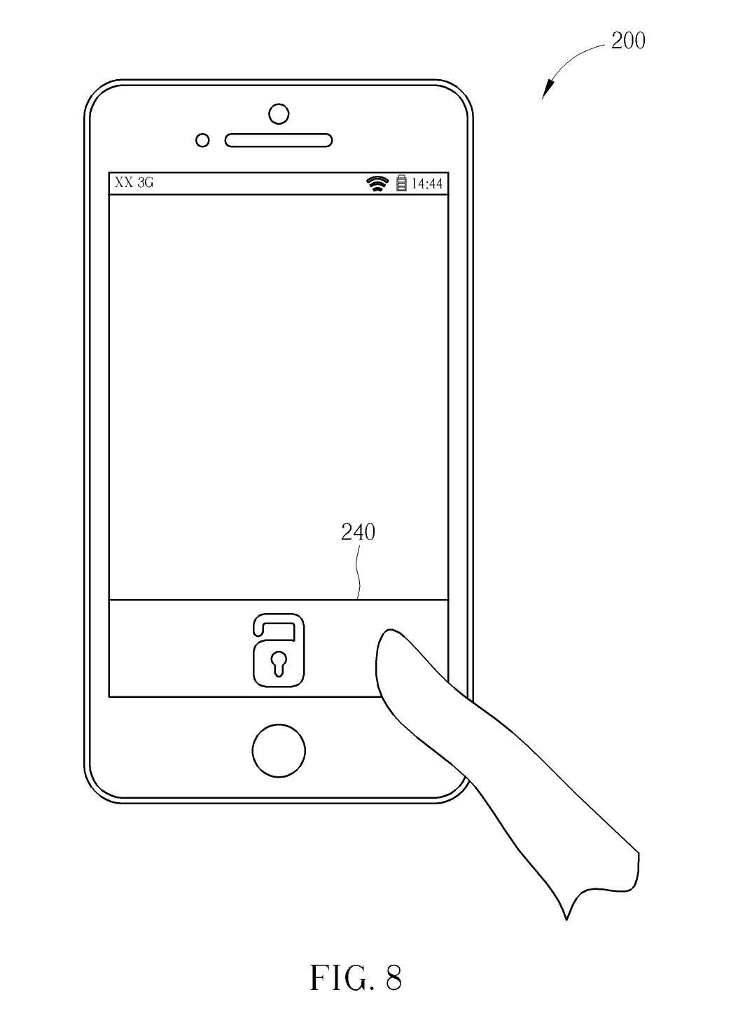

In one embodiment, if the touch event is received within the isolation window, a notice message will be generated, inquiring of the user about whether to de-activate the isolation mechanism, thereby to allow the user to handle the content in the isolation area. FIG. 7 is a flow chart of generating a notice message that inquires of the user whether to de-activate the isolation mechanism according one embodiment of the present invention. At first, if the touch event occurs within the isolation window 240, step 410 generates a notice message in the isolation window 240. In step 420, it is determined whether an input event is associated with the notice message. If yes, the isolation window 240 will be closed; otherwise, the notice message will be cancelled. FIG. 8 illustrates an exemplary isolation window according to one embodiment of the present invention. For example, if the user's touch occurring inside the isolation window 240, a lock icon as depicted by FIG. 8 will be generated in the isolation window 240. As long as the user touches the lock icon again, it may represent that the user does not need the isolation mechanism. Thus, the isolation window 240 will be closed. At this time, if the user again touches the advertising area underneath the isolation window 240, the OS may direct the user interface to a web page in accordance with the configuration of the advertising area. If the user again touches the navigation bar underneath the isolation window 240, the OS may perform corresponding operations.

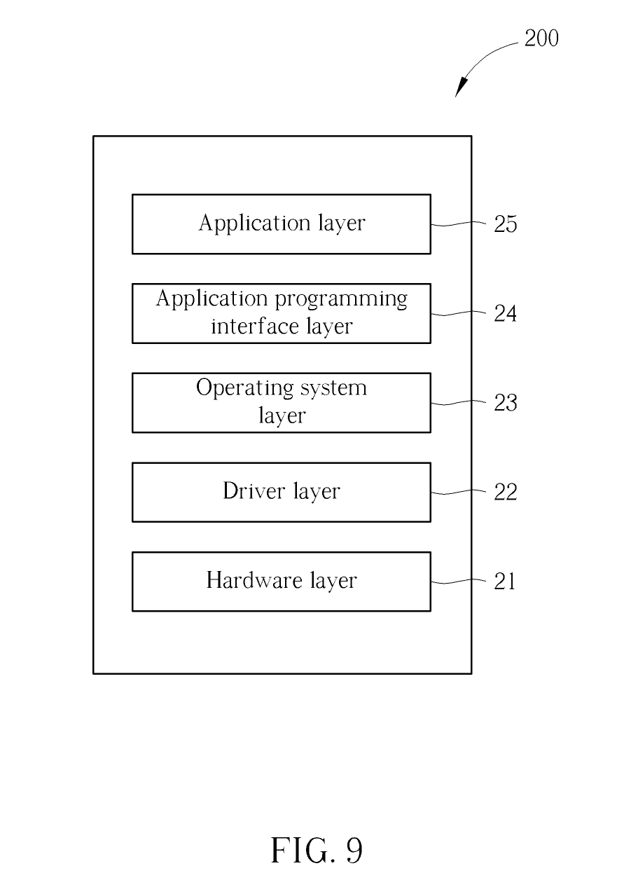

The following will elaborates how the touch controlled device 200 executes the method of the present invention from system point of view. FIG. 9 illustrates a schematic diagram of the touch controlled device 200 according to one embodiment of the present invention. Please refer to the schematic diagram of the touch controlled device 200 shown by FIG. 9. A hardware layer 21 of the touch controlled device 200 comprises various hardware components, such as, touchscreen for displaying the user interface 210 and capturing user's touch control. The hardware layer 21 also comprises processors and memories for executing the OS and applications. A driver layer 22 comprises one or more driver programs for communicating with various hardware components, issuing commands to the hardware components for specific operations and receiving and processing data from the various hardware components. An operating system layer 23 communicates with the driver programs and processes data passed from the hardware components through the driver programs. An application programming interface layer 24 comprises application programming interfaces for various purposes which allows applications in an application layer 25 to communicate with the operating system layer 23 and control hardware components through the operating system layer 23, and also derived data from the hardware layer 21 or ask specific hardware components to perform certain operations.

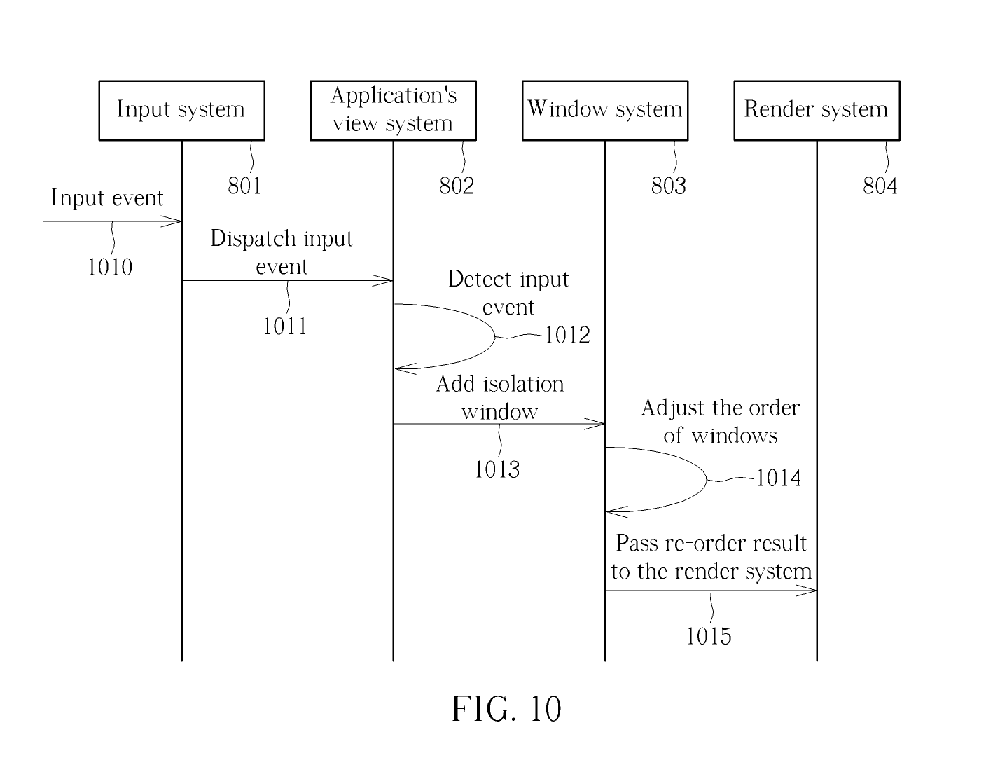

FIG. 10 illustrates how an isolation window be added to the touch controlled device 200 according to one embodiment of the present invention. Please note that reference in FIG. 10 to specific “system” could be implemented based on interoperations between components belonging to one or multiple layers illustrated by FIG. 9. In step 1010, an input system 801 receives an input event generated by the user. The input system 801 will dispatch the input event to an application's view system 802 (step 1011). In step 1012, the application's view system 802 detects the input event, where the application's view system 802 is a software system that executes the method of the present invention. When it is detected that the input event is related to the above-mentioned specific operation intended for activating the isolation window (e.g. press and hold on the back option 231), the application's view system 802 executes step 1013 requests a window system 803 in the framework layer of the operating system layer 23 to add the isolation window. The window system 803 also adjust the order of the windows (step 1014), to place the generated isolation window in front of all the other windows (e.g. windows generated by the applications are being executed) and make the isolation window on the topmost layer over the desktop. The present invention could modify the window system 803 in advance, which allows the isolation window generated by the present invention to have the highest priority over all the other windows such that the isolation window can be always placed in front of all the other windows. Then, the window system 803 passes the re-order result of windows to a render system 804 (step 1015). The render system 804 accordingly renders the user interface. As a result, the flow of activating the isolation window 240 and displaying the isolation window 240 can be ended. Accordingly, the present invention configures the size and the position of the isolation window 240.

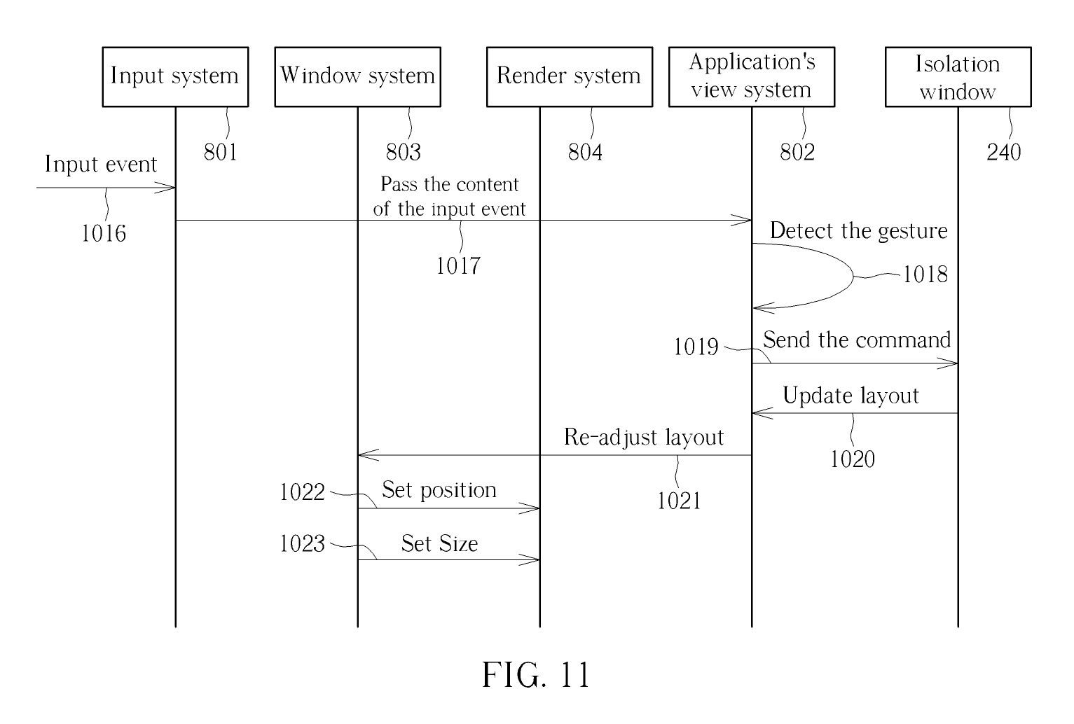

FIG. 11 illustrates how the touch controlled device 200 configures the isolation window 240 according to user's operation according to one embodiment of the present invention. Please note that reference in FIG. 11 to specific “system” could be implemented based on interoperations between components belonging to one or multiple layers illustrated by FIG. 9. In step 1016, the input system 801 receives the user's input event, and content of the input event is related to adjusting the size and the position of the isolation window. The input system 801 passes the content of the input event to the application's view system 802 in step 1017. In step 1018, the application's view system 802 detects the content of the input event. That is, gestures included in the input event, such as dragging by single finger or pinching by double fingers. Accordingly, in step 1018, the content of the gestures will be translated to commands, and in step 1019, the commands will be sent to isolation window 240. In step 1020, the isolation window 240 sends a request for updating layout of the window (e.g. adjusting the size or the position of the window) to the application's view system 802. In step 1021, the application's view system 802 further sends this request to the window system 803, and the window 803 determines to adjust the size or the position of the isolation window according to content of the request, and sends information regarding the content of the request to the render system 804 (step 1022 and step 1023). Accordingly, the render system adjusts the isolation window 240.

### Second Embodiment

In the second embodiment of the present invention, the isolation mechanism is activated automatically without user's specific manipulation. In this embodiment, the present invention detects content of configuration of specific application programming interfaces (API) of operation system of touch controlled device. The principle of the second embodiment is that advertisement contents of an application usually rely upon specific API to be displayed in the user interface. Taking Android system as an example, “Surface View” API is commonly used in virtualization of advertising areas. Thus, if an application needs to present some advertisement contents, the application usually uses such API to generate an advertising area in the user interface. If the content of the configuration of such API is analyzed, it could be determined whether the user interface includes the advertising area. Additionally, the content of the configuration of the API also includes information regarding the size of the advertising area and the actual position in the user interface. Thus, the embodiment could directly pick up possible advertising areas according to the content of the configuration of the API.

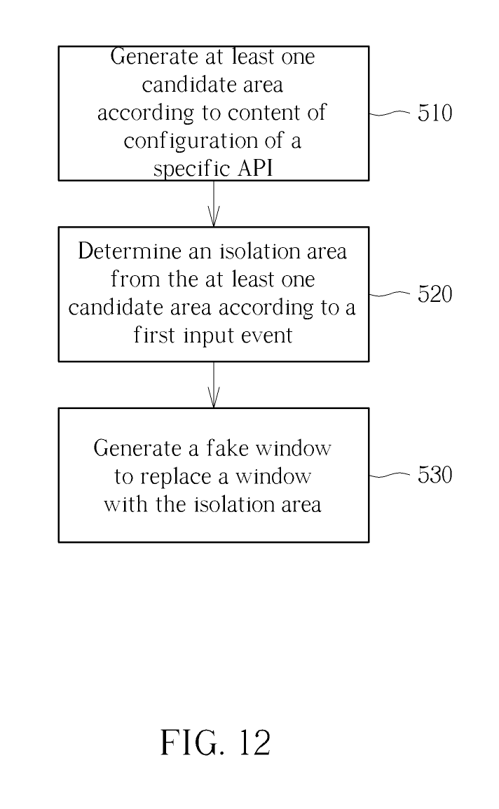

FIG. 12 illustrates a flow chart of activating the isolation mechanism according to one embodiment of the preset invention. At first, at least one candidate area will be generated according to the content of the configuration of a specific API in step 510. In step 520, according to a first input event, determine the isolation area from the at least one candidate area. In step 510, if it is detected the usage of the specific API, the candidate areas could be determined according to the content of the configuration of the specific API. In these candidate areas, not all of them are advertising areas. This is because other contents of the application may also use such API. Hence, to correctly determine whichever candidate area is the advertising area that needs to be isolated, step 520 is executed. In step 510, the candidate area will be marked. For example, the border of the candidate area could flash or has specific surrounding lines thereon. The user can therefore recognize the candidate area determined based on the content of the configuration of specific API. In step 520, according to the first input event generated by the user, it is determined whichever candidate area needs to configured as the isolation area. For example, the user could select whichever candidate area is an advertising area or a navigation bar. Alternatively, the user may select one or more of the candidate areas that he/she does not intend to touch. The selected candidate areas could be determined as the isolation area by, for example, user's clicking. In addition, the user may select one or more the candidate areas as the isolation area by touch controls through the touchscreen of the touch controlled device 200 or by pressing physical buttons of the touch controlled device 200.

In step 530, the present invention introduces a fake window to the OS. The fake window will replace the window that is generated by the specific API inside the isolation area and sets an association with the touch events. When the position where the touch event occurs is detected, the OS will find out the objects at the position, such as the function options, the advertising areas, or the navigation bar. Then, the OS will set up the association between the touch event and the found object, thereby making the object have a proper response to the touch event. The present invention uses the fake window to replace the object and intercept the touch events. As a result, the touch event will not be dispatched to the objects in the isolation area and fails to be associated with these objects.

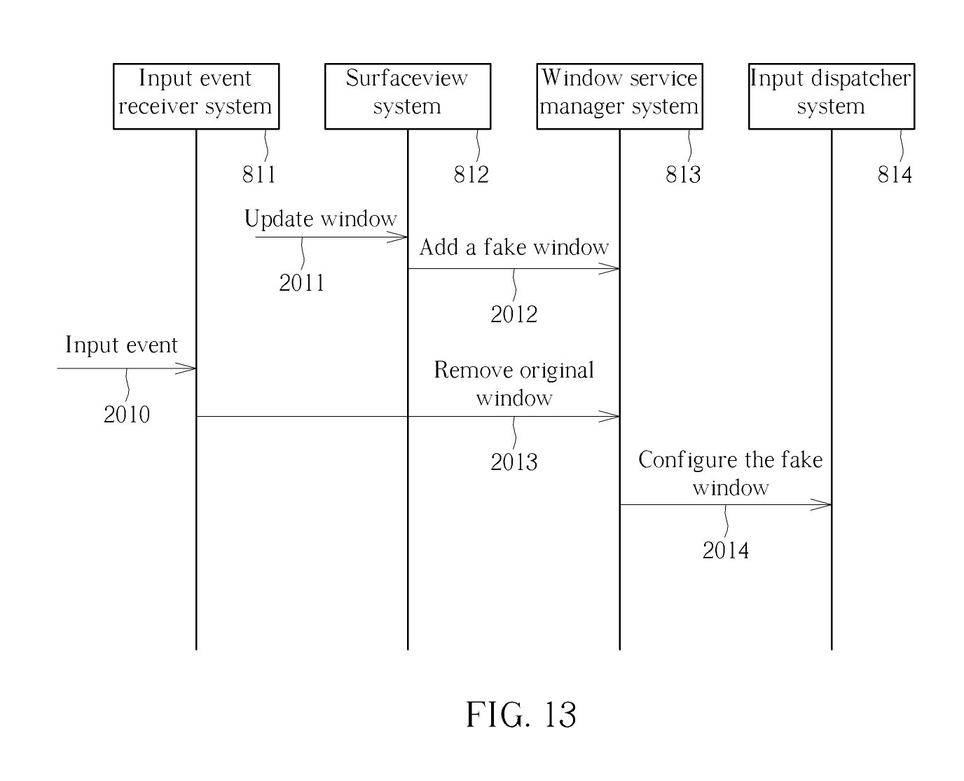

FIG. 13 illustrates how the touch controlled device 200 generates a fake window according to one embodiments of the present invention. Please note that reference in FIG. 13 to specific “system” could be implemented based on interoperations between components belonging to one or multiple layers illustrated by FIG. 9. In step 2010, an input event receiver system 811 receives a command (e.g. an input event) issued by the method of the present invention, which requests for isolating the advertising area. In step 2013, a window service manager system 813 is requested to remove windows in the isolation area that is determined by the user. A SurfaceView system 812 receives a request from the present invention for updating the window (in step 2011). At the same time, the window service manager system is requested to add a fake window (in step 2012). In step 2014, an input dispatcher system 814 is requested to direct all the touch events occurring on the isolation area to the fake window. As a consequence, all the touch events occurring on the isolation area are merely sent to the fake window, and these touch event will not be associated to the other windows (e.g. navigation bar or advertising area) inside the isolation area, thereby avoiding the undesirable effects of unintentional touches.

In this embodiment, no visible windows are generated for blocking the touch events. Instead, in this embodiment, touch events regarding the isolation area will be directly intercepted in the OS level such that the navigation bar or the advertising area in the isolation area has no chance to be informed of the touch events.

### Third Embodiment

In a third embodiment of the present invention, another method is adopted to block the touch events on the isolation area. In the first and second embodiments, framework layer of the OS needs to be modified. For example, in the first embodiment, the rules of ordering windows need to be changed such that the isolation window can be placed over the top of all other windows. In the second embodiment, objects in the isolation area need to be removed from the window service manager system to make the objects fail to be associated with the touch event. This also needs to modify the framework layer of the OS. However, the third embodiment achieves the same effect without modifying the framework layer of the OS.

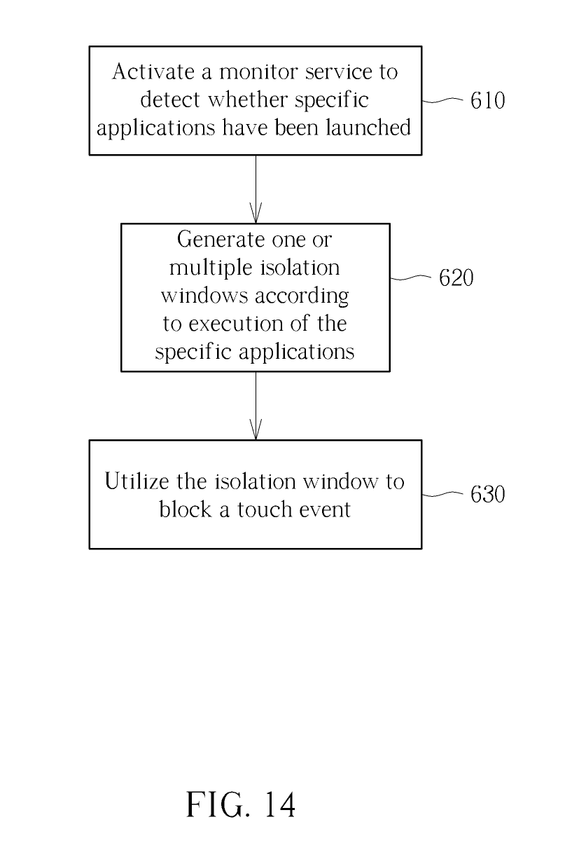

FIG. 14 illustrates a flow chart of activating isolation mechanism according to one embodiment of the present invention. In step 610, a monitor service is activated, which can detect whether specific applications have been launched or are executing. Afterwards, in step 620, one or multiple isolation windows are generated according to the execution of the specific applications. The method is suitable to certain cases where it is known that the application does have advertisement contents. For example, well-known free software applications usually include advertisement contents provided by sponsors. When these applications are executed, advertising areas will be shown in the user interface. Hence, in step 610, when the monitor service detects these applications are launching, the isolation window is automatically generated (e.g. a floating window), wherein the isolation window could be over the top of the window of the application. Then, the user could scale or move the isolation window onto the top of the advertising area by applying the touch controls mentioned in the first embodiment such that the isolation area can be determined. In step 630, if the unintentional touch occurs on the isolation area, the isolation window can block this touch event.

This embodiment does not modify the window system in the framework layer to change the order of the windows as illustrated in the first embodiment. Instead, this embodiment just superimposes the isolation window onto the window of the application because the window of latter-executed application needs to be in front of the window of former-executed application. Thus, this embodiment needs not to modify the framework layer of the OS but still can achieve the goal of isolating the touch events

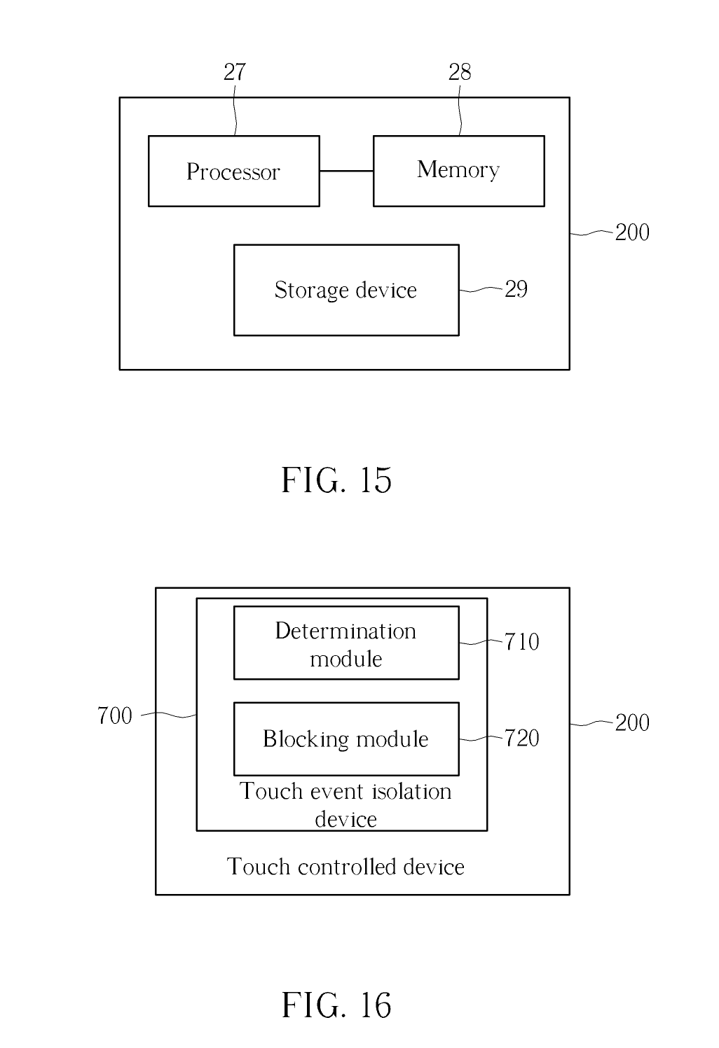

The method of the present invention could have various implementations. FIG. 15 illustrates a touch controlled device 200 implemented on software architecture according to one embodiment of the present invention. In this embodiment, the touch controlled device 200 comprises: a processor 27, a memory 28 and a storage device 29. The method of the present invention is translated to program codes and stored into the storage device 29. The storage device 29 could a flash memory or a hard disk drive. The processor 27 loads the program codes from the storage device 29 and stores them to the memory 28. The memory 28 generally could be a random access memory, and particularly could be a static random access memory or a dynamic random access memory. The processor 27 reads the program codes from the memory 28 and executes. As a result, the isolation mechanism can be implemented.

FIG. 16 illustrates a block diagram of a touch event isolation device according to one embodiment of the present invention, which comprises: a determination module 710 and a blocking module 720. It should be noted that the determination module 710 and the blocking module 720 as illustrated in FIG. 16 could be implemented based on interoperations between components belonging to one or multiple layers of FIG. 9. One of ordinary skill in the art could select different components from these layers based on different requirements. The touch event isolation device 700 could be disposed in the touch controlled device 200 to process touch events in the touch controlled device 200. The determination module 710 is employed for determining an isolation area of a user interface displayed by the touch controlled device 200. The determination module 710 could execute steps illustrated in FIG. 4, FIG. 6, FIG. 7, FIG. 12 and FIG. 14. For example, the touch controlled device 200 could generate the isolation window and determines the isolation area according to user's specific manipulations/gestures. Alternatively, determination module 710 could determine possible isolation areas (candidate area) according to the content of the configuration of specific application interface, and the user acknowledges which of candidate areas should be the isolation area. Alternatively, the determination module 710 may automatically generate the isolation window according to the activation of specific applications and the user sets the isolation window to determine the isolation area.

The blocking module 720 is employed for blocking the touch events occurring on the isolation area. The blocking module 720 could execute steps illustrated in FIG. 4, FIG. 6, FIG. 7, FIG. 12 and FIG. 14. For example, the blocking module 720 may use the generated isolation window to receive the touch event, making the area underneath the isolation window fail to receive the touch event. Alternatively, the blocking module 720 may generate a fake window in the OS to intercept the touch event such that the touch event cannot be dispatched to objects in the isolation area.

With the isolation mechanism of the present invention, the undesirable effects of the unintentional touches could be alleviated. In most cases, user's manipulation will not be affected, thereby improving the convenience of the touch control.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch event isolation method, for processing a touch event of a touch controlled device, comprising:
determining an isolation area of a user interface displayed by the touch controlled device; and
blocking the touch event occurring on the isolation area.

2. The touch event isolation method of claim 1, wherein the step of determining the isolation area comprises:
generating an isolation window according to a first input event; and
placing the isolation window over the top of a specific area of the user interface according to a second input event to determine the isolation area.

3. The touch event isolation method of claim 2, wherein the step of determining the isolation area further comprises:
configuring a size of the isolation window according to a third input event.

4. The touch event isolation method of claim 2, wherein the step of blocking the touch event occurring on the isolation area comprises:
utilizing the isolation window to receive the touch event, making the touch event fail to be associated with the specific area.

5. The touch event isolation method of claim 2, further comprising:
when the touch event occurs in the isolation window, generating a notice message in the isolation window; and
closing the isolation window according to a fourth input event corresponding to the notice message.

6. The touch event isolation method of claim 2, wherein the isolation window is transparent or translucent.

7. The touch event isolation method of claim 1, wherein the step of determining the isolation area comprises:
generating at least one candidate area according to content of configuration of a specific application programming interface; and
determining the isolation area from the at least one candidate area according to a first input event.

8. The touch event isolation method of claim 7, wherein the step of generating the at least one candidate area comprises:
according to the content of the configuration of the specific application programming interface, marking a border of at least one specific area of the user interface to be the at least one candidate area.

9. The touch event isolation method of claim 7, wherein the step of blocking the touch event occurring on the isolation area comprises:
generating a fake window to replace a window in the isolation area that is generated by the specific application programming interface, and making the fake window associated with the touch event.

10. The touch event isolation method of claim 1, wherein the step of determining the isolation area comprises:
utilizing a monitor service to monitor whether a specific application is launching;
generating at least one isolation window when the specific application is launching; and
placing the isolation window over the top of a specific area of the user interface according to a first input event to determine the isolation area.

11. A touch event isolation device, for processing a touch event in a touch controlled device, comprising:
a determination module, for determining an isolation area of a user interface displayed by the touch controlled device; and
a blocking module, for blocking the touch event occurring on the isolation area.

12. The touch event isolation device of claim 11, wherein the determination module generates an isolation window according to a first input event and determines the isolation area by placing the isolation window over the top of a specific area of the user interface according to a second input event.

13. The touch event isolation device of claim 12, wherein the determination module configures a size of the isolation window according to a third input event.

14. The touch event isolation device of claim 12, wherein the blocking module utilizes the isolation window to receive the touch event, thereby making the touch event fail to be associated with the specific area.

15. The touch event isolation device of claim 12, wherein when the touch event occurs in the isolation window, the determination module generates a notice message in the isolation window, and the blocking module selectively closes the isolation window according to a fourth input event corresponding to the notice message.

16. The touch event isolation device of claim 11, wherein the determination module generates at least one candidate area according to content of configuration of a specific application programming interface and determines the isolation area from the at least one candidate area according to a first input event.

17. The touch event isolation device of claim 16, wherein the determination module marks a border of at least one specific area of the user interface to be the at least one candidate area according to the content of the configuration of the specific application programming interface.

18. The touch event isolation device of claim 16, wherein the blocking module utilizes a fake window to replace a window in the isolation area that is generated by the specific application programming interface, thereby making the fake window associated with the touch event.

19. The touch event isolation device of claim 11, wherein the determination module utilizes a monitor service to monitor whether a specific application is launching; generates at least one isolation window when the specific application is launching, and placing the isolation window over the top of a specific area of the user interface according to a first input event to determine the isolation area.

20. A computer readable medium containing a set of computer readable instructions that when loaded into a computer configure that computer to:
determining an isolation area of a user interface displayed by the touch controlled device; and
blocking the touch event occurring on the isolation area.
